(19) United States
(12) Patent Application Publication
(10) Pub. No.: US 2005/0284011 A1
(43) Pub. Date: Dec. 29, 2005

(54) Changeable message display system

(76) Inventor: Curtis L. Todd, St. Louis, MO (US)

Correspondence Address: Thomas A. Polcyn;Thompson Coburn LLP, Suite 3500, One US Bank Plaza, St. Louis, MO, 63101-9928, US

(21) Appl. No.: 10/879,993

(22) Filed: Jun. 29, 2004

(51) Int. Cl. G09F 15/02; G09F 7/04

(52) U.S. Cl. 40/600; 40/607.05

(57) ABSTRACT

A changeable message display system comprises a magnetically attractable signboard, a plurality of signs, and a sign support. The signboard has an outer perimeter that defines a generally planar sign-receiving surface. Each of the signs is formed of a unitary piece of flexible magnetic sheet material. Each of the signs has dimensions that are substantially the same as the sign-receiving surface of the signboard. Each of the signs is adapted for removable connection to the signboard by magnetic attraction in a manner so that, when connected, the sign is generally co-extensive with substantially the entire sign-receiving surface of the signboard.

### BACKGROUND OF THE INVENTION

The invention relates to the field of signage and, more particularly, to temporary or changeable signs that may be used in home, office, commercial, institutional and industrial environments, where there is a need identify addresses, direct visitors or delivery persons, or provide greetings or other information of a temporary nature.

It is well known to use signs to display information. In some cases, such signs are intended to be permanent in nature, making it impractical to change the information on them frequently. It is also well known to use portable, temporary signs to display messages or information. In some cases, such temporary signs are made of relatively inexpensive materials (e.g., paper board mounted on a wood stake) and are intended to be disposable if the information is displayed on them is of a permanent nature (e.g., ink, paint, etc.). While such temporary signs are inexpensive and easy to use, they are too informal for certain applications. In other cases, especially in commercial environments, changeable signs with removable letters or other removable components are used to display information that may change frequently (e.g., restaurant menu boards, theatre marquees, etc.). These are often more aesthetically acceptable than the aforementioned disposal signs, and provide a convenient may to change information to be displayed, but the individual letters or components are prone to being misplaced, stolen, or knocked out of alignment (especially in the case of outdoor signage of this type), which is aesthetically unacceptable and may result in the display of incomplete information.

Thus, there is a need for a changeable message display system that permits messages to be changed easily, that is aesthetically attractive, that is portable and relatively inexpensive, and that is not prone to having individual message components inadvertently removed or misaligned in a way that may result in the display of incomplete information.

### SUMMARY OF THE INVENTION

To remedy the above noted problems, a changeable message display system of the present invention comprises a magnetically attractable signboard and a plurality of signs. The signboard has an outer perimeter that defines a generally planar sign-receiving surface. Each of the signs is formed of a unitary piece of flexible magnetic sheet material. Each of the signs has dimensions substantially the same as the sign-receiving surface of the signboard. Each of the signs is adapted for removable connection to the signboard by magnetic attraction in a manner so that, when connected, the sign is generally co-extensive with the sign-receiving surface of the signboard. The signs and signboard are preferably constructed of durable, weather-resistant materials suitable for long-term outdoor use.

In another aspect of the invention, a changeable message display system comprises a magnetically attractable signboard and a sign. The signboard has an outer perimeter defining a generally planar sign-receiving surface. The sign is formed of a unitary piece of flexible magnetic sheet material and has dimensions corresponding to dimensions of the sign-receiving surface. The sign is removably connected to the sign-receiving surface of the signboard by magnetic attraction in a manner so that the sign is generally coextensive with substantially the entire sign-receiving surface.

In still another aspect of the invention, a method is provided for displaying temporary messages. The method comprises the steps of providing a magnetically attractable signboard, providing a plurality of signs, selecting one of the signs, and removably connecting the sign to the signboard. The magnetically attractable signboard includes an outer perimeter that defines a generally planar sign-receiving surface. Each of the signs is formed of a unitary piece of flexible magnetic sheet material and has dimensions substantially the same as the sign-receiving surface of the signboard. The step of removably connecting the selected sign includes removably connecting the sign to the sign-receiving surface of the signboard by magnetic attraction in a manner so that the sign is generally coextensive with the sign-receiving surface of the signboard.

Further objects, features, and advantages of the present invention, as well as the structure and operation of various embodiments of the present invention, are described in detail below with reference to the accompanying drawings.

### BRIEF DESCRIPTION OF THE DRAWINGS

FIG. 1 is a front elevational view of a changeable message display system of the present invention;

FIG. 2 is a front elevational view of a signboard component of the changeable message display system of FIG. 1;

FIG. 3 is an exploded view of the changeable message display system of FIG. 1, showing a removable sign spaced from a signboard for illustrative purposes;

FIG. 4 is a cross-sectional view of the changeable message display system of FIG. 1 taken through the plane of line 4-4;

FIG. 5 is an enlarged, fragmented cross-section view of an edge portion of the signboard with removable sign; and

FIG. 6 is an exploded view of an alternative embodiment of the changeable message display system of the present invention, showing the manner in which multiple removable signs may overly one another, the signs being spaced from a signboard and from one another for illustrative purposes.

Reference characters used in these drawings correspond with reference characters used throughout the Detailed Description of the Preferred Embodiments, which follows. These drawings, which are incorporated in and form a part of the specification, illustrate the preferred embodiments of the present invention and, together with the description, serve to explain the principles of the invention.

### DETAILED DESCRIPTION OF THE PREFERRED EMBODIMENTS

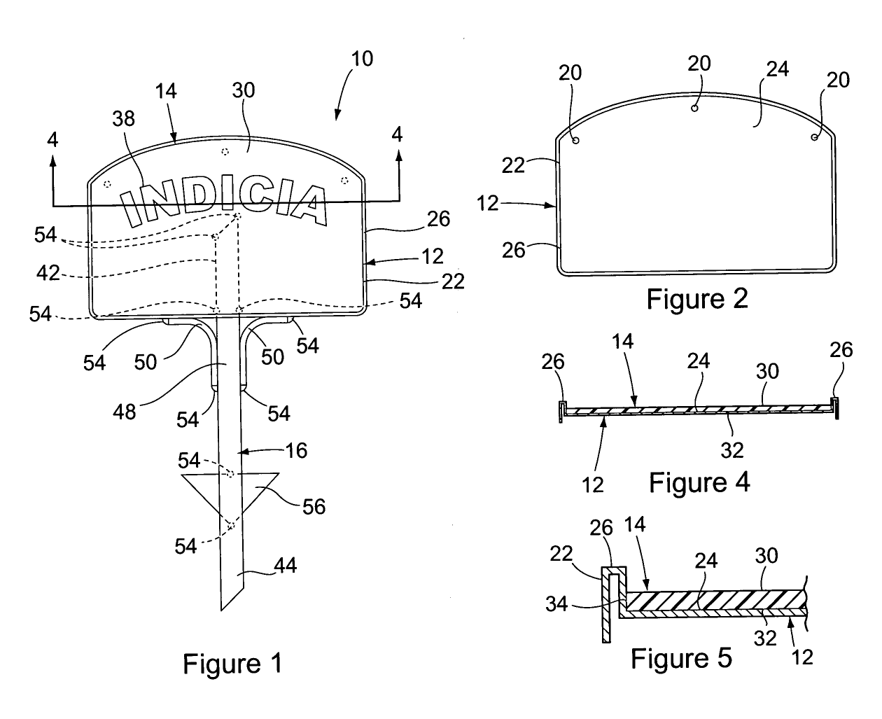

A changeable message display system of the present invention is represented generally by the reference numeral 10 in FIG. 1. In general, the system 10 comprises a signboard 12, a removable sign 14 and a support member 16.

FIG. 2 shows the signboard 12 without the other components of the device. The signboard is preferably formed of a magnetically attractable material, such as steel, though it could be formed of other suitable magnetically attractable material without departing from the scope of the present invention. Preferably, the signboard 12 is of a unitary construction formed from casting, stamping or other suitable process, as is known in the art. As shown in FIG. 2, the signboard 12 preferably includes a plurality of apertures 20 for accepting mechanical fasteners (not shown). As explained hereinafter, in one embodiment of the invention, these apertures 20 and mechanical fasteners may be used for mounting the signboard 12 to a wall or other generally vertical surface, as explained hereinafter.

The signboard 12 includes an outer perimeter 22 that defines a generally planar sign-receiving surface 24 of the signboard. As best shown in FIG. 5, the outer perimeter 22 preferably includes a narrow, perimetrical ridge 26 that extends about the outer perimeter and protrudes from the sign-receiving surface 24, such that the sign-receiving surface 24 is slightly recessed in the signboard 12. Preferably, this ridge 26 is formed by embossing, but could be formed by another suitable process without departing from the scope of the present invention.

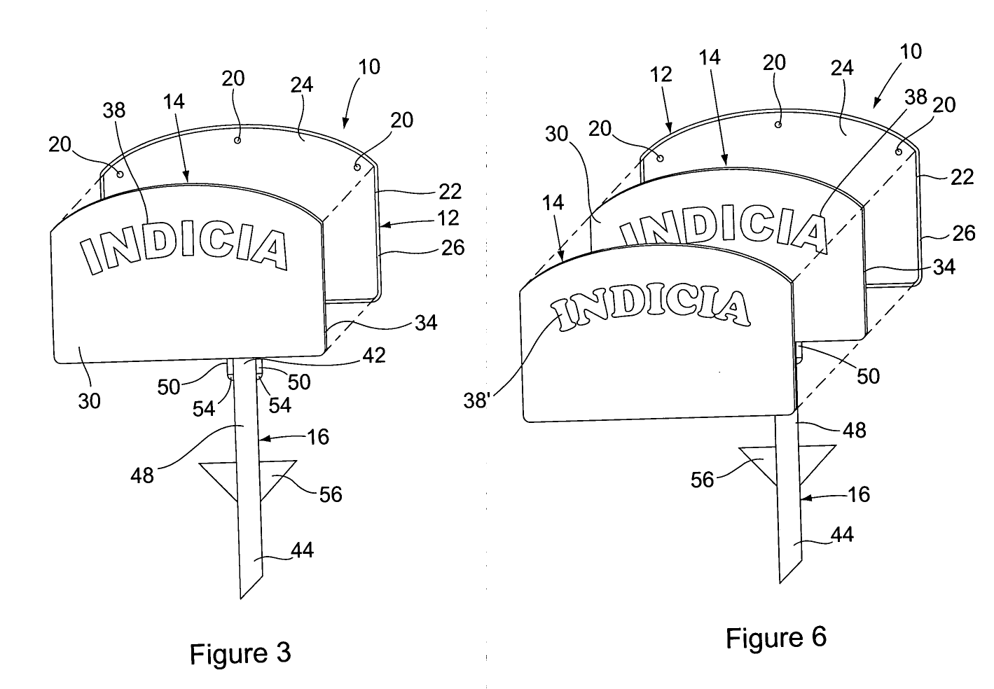

FIG. 3 is an exploded view of the changeable message display system 10, showing a removable sign 14 spaced from a signboard 12 for illustrative purposes. Preferably, the sign 14 is formed of a unitary piece of flexible magnetic sheet material. Flexible, rubberized magnetic sheet material is known in the art. Such magnetic sheet material is typically provided in large rolls or large sheets and is die cut or otherwise cut to size for use in various applications, such as magnetic business cards, magnetic calendars, magnetic baseball schedules, temporary displays for vehicle bodies, etc. In this case, the magnetic sheet material is preferably pre-cut to the desired size before being used in the changeable message display system 10 of the present invention. Such magnetic sheet material is typically between 10 and 150 mils thick, though magnetic sheet material having thicknesses outside this range could be used without departing from the scope of the present invention.

Preferably, the sign 14 has a has a front face 30 and an opposite rear face 32 (see FIGS. 4 and 5), and also has a outer edge margin 34 that extends about the perimeter of the sign 14. The front face 30 of the sign 14 preferably carries pre-printed text, graphics and/or other indicia 38. Such indicia 38 may include things such as an address, a name of a person, company, facility, room or other location, a greeting, a holiday-themed message, or other information. Possibilities are virtually limitless in this regard. The rear face 32 of the sign is preferably unprinted. As shown in FIGS. 1 and 3, the sign 14 preferably has overall dimensions that are substantially the same as and correspond to overall dimensions of the sign-receiving surface 24 of the signboard 12. As shown in FIG. 1, the sign 14 is removably connectable to the sign-receiving surface 24 of the signboard 12 by magnetic attraction. As best shown in FIGS. 4 and 5, the sign 14 is preferably magnetically connected to the sign-receiving surface 24 of the signboard 12 in a manner so that the sign 14 is in direct engagement with the sign-receiving surface 24. Because the overall dimensions of the sign 14 are substantially the same as and correspond to the overall dimensions of the sign-receiving surface 24, the sign 14 coextensive with substantially the entire sign-receiving surface 24 of the signboard 12 when magnetically connected to the signboard 12, resulting in a clean and unbroken appearance of the changeable message display system 10.

As best shown in FIGS. 4 and 5, the sign 14 is dimensioned to fit against the generally planar sign-receiving surface 24 and within the perimetrical ridge 26 of the signboard 12. The ridge 26 thus provides a convenient means facilitating proper positioning of the sign 14 on the signboard 12 by the user. The ridge 26 also protects the sign 14 from being inadvertently knocked out of alignment or otherwise separated from the signboard 12 when the system 10 is subjected to external forces, such as collisions by persons or objects, high winds, etc. The ridge 26 also serves the aesthetic function of completing the overall appearance of the signboard 12 and is preferable to sharp edges. Of course, the changeable message display system 10 could just as easily employ a signboard 12 having no protruding perimetrical ridge without departing from the scope of the present invention.

Preferably, the sign 14 is just one of a plurality of such signs, which may be used interchangeably. Preferably, each such sign is formed of a unitary piece of flexible magnetic sheet material and has dimensions that correspond to dimensions of the sign-receiving surface 24 of the signboard 12. Also preferably, each such sign adapted for removable connection to the sign-receiving surface 24 of the signboard 12 in the same manner described above in reference to sign 14. When each such sign bears indicia that is distinct from the indicia carried by the other signs, the signs can be used interchangeably in the system 10 to selectively display different messages or information on the signboard 12. As shown in FIGS. 3, 4 and 5, this can be done using one sign at a time, with said sign 14 being in direct engagement with the sign-receiving surface 24 of the signboard 12. Thus, a method of the present invention for changing signs comprises the steps of: removing a first selected sign from the signboard 12; selecting a second sign; and removably connecting the second selected sign to the sign-receiving surface 24 of the signboard 12, after the first selected sign is removed from the signboard.

FIG. 6 is an exploded view of an alternative embodiment of the changeable message display system 10 of the present invention, illustrating the use of multiple removable signs 14 and 14′ overlying one another. Thus, as shown in FIG. 6, multiple signs are removably connectable to the signboard 12 by magnetic attraction simultaneously in laminar fashion, with said signs being generally coextensive with one another and also generally coextensive with the sign-receiving surface 24 of the signboard 12. FIG. 6 illustrates two such signs 14 and 14′. However, more than two signs could be used in this fashion without departing from the scope of the present invention. This provides a convenient means for storing signs that are not being displayed, and permits ready access to them when the message is to be changed. Thus, an alternative method of the present invention for changing signs comprises the steps of: removably connecting a first selected sign 14 to the signboard 12 by magnetic attraction; selecting a second sign 14′; and removably connecting the second selected sign 14′ to the signboard 12 by magnetic attraction, without removing the first selected sign 14 from the signboard 12, so that the second selected sign 14′ overlies the first selected sign 14 and is generally coextensive with both the first selected sign 14 and the sign-receiving surface 24.

Referring back to FIG. 2, the signboard 12 is shown to have a plurality of apertures 20 for accepting mechanical fasteners (not shown). In one embodiment of the invention, these apertures 20 and mechanical fasteners may be used for mounting the signboard 12 to a wall or other generally vertical surface. The signs 14 are then magnetically connectable to the sign-receiving surface 24 of the wall-mounted signboard 12 in the fashion described previously. The signs 14 may be used interchangeably, one sign at a time, or, as discussed above in connection with the embodiment shown in FIG. 6, may overly one another in a laminar fashion so that the signs are generally coextensive with one another and with the sign-receiving surface 24. Preferably, the apertures 20 are countersunk, so that the mechanical fasteners used therein do not interfere with connection of the signs 14 to the sign-receiving surface 24.

As shown in FIGS. 1, 3 and 6, another embodiment of the system 10 preferably includes a sign support member 16 connected to the signboard 12 and adapted to support the signboard 12, and the sign(s) 14 carried thereby, over a generally horizontal support surface (not shown). Preferably, the sign support member is a signpost 16 comprising an elongate member having an proximate upper end 42 and a lower distal end 44. Also, preferably, the distal end 44 is sharpened to facilitate driving the signpost into horizontal support surface (e.g., the ground). Thus, a method of the present invention further comprises the steps of: providing a signpost 16 connected to the signboard 12; and driving a sharpened distal end 44 of the signpost 16 into a generally horizontal support surface to support the signboard 12, and the sign(s) 14 carried thereby, over the support surface. This embodiment of the invention is, therefore, particularly suited for use as a yard sign.

The signpost 16 itself is preferably formed of tubular steel (or another suitable material having sufficient strength characteristics) having a generally rectangular cross-sectional configuration, with at least one flat side 48 configured to engagement with a rear side of the signboard 12, though signposts having other configurations could be used without departing from the scope of the invention. The signpost 16 may also include one or more support brackets 50 (e.g., formed of cold rolled stock or another suitable material) for ornamental purposes. The support brackets 50 also preferably provide enhanced lateral support for the signboard 12.

A preferred manner of connecting the signpost 16, signboard 12 and support brackets 50 to one another is with MIG (metal inert gas) tack welds in select locations 54, though other attachment means could be employed, without departing from the scope of the invention. In addition, in the preferred embodiment of the device, the signpost 16 includes a stabilizer blade 56 (also preferably connected to the signpost 16 with MIG tack welds in select locations 54), which is adapted to be driven at least partially into the ground along with the distal end 44 of the signpost 16. A flat upper edge of the stabilizer blade 56 is configured so that a user may step on the blade 56 to facilitate driving the distal end 44 of the signpost 16 into the ground. When at least partially driven into the ground, the stabilizer blade 56 also helps to resist rotation of the sign (e.g., due to high winds).

As various modifications could be made in the constructions and methods herein described and illustrated without departing from the scope of the invention, it is intended that all matter contained in the foregoing description or shown in the accompanying drawings shall be interpreted as illustrative rather than limiting. Thus, the breadth and scope of the present invention should not be limited by any of the above-described exemplary embodiments, but should be defined only in accordance with the following claims appended hereto and their equivalents.

1. A changeable message display system comprising:
a magnetically attractable signboard having an outer perimeter that defines a generally planar sign-receiving surface;
a plurality of signs, each of said signs being formed of a unitary piece of flexible magnetic sheet material and having dimensions substantially the same as the sign-receiving surface of the signboard, each of said signs being adapted for removable connection to the signboard by magnetic attraction in a manner so that, when connected, the sign is generally coextensive with the sign-receiving surface of the signboard.

2. The changeable message display system of claim 1 wherein each of said signs is adapted for removable connection to the sign-receiving surface of the signboard by magnetic attraction in a manner so that the sign is in direct engagement with the sign-receiving surface of the signboard.

3. The changeable message display system of claim 1 wherein said signs are shaped and adapted so that multiple signs are removably connectable to the signboard by magnetic attraction simultaneously in laminar fashion, with said signs being generally coextensive with one another and generally coextensive with the sign-receiving surface of the signboard.

4. The changeable message display system of claim 1 wherein each signs bears indicia that is distinct from indicia carried by other signs.

5. The changeable message display system of claim 1 wherein the outer perimeter of the signboard includes a perimetrical ridge that protrudes from the generally planar sign-receiving surface, each of said signs being dimensioned to fit against the generally planar sign-receiving surface and within the perimetrical ridge of the signboard.

6. The changeable message display system of claim 1 further comprising a sign support connected to the signboard, the sign support being adapted to support the signboard over a generally horizontal support surface.

7. The changeable message display system of claim 6 wherein the sign support is a signpost having a sharpened distal end, and the generally horizontal support surface is the ground, the sharpened distal end of the signpost being adapted to facilitate driving the signpost into the ground.

8. A changeable message display system comprising:
a magnetically attractable signboard with an outer perimeter defining a generally planar sign-receiving surface;
a sign formed from a unitary piece of flexible magnetic sheet material and having dimensions that correspond to dimensions of the sign-receiving surface of the signboard, the sign being removably connected to the sign-receiving surface of the signboard by magnetic attraction in a manner so that the sign is coextensive with substantially the entire sign-receiving surface of the signboard.

9. The changeable message display system of claim 8 wherein said sign is one of a plurality of said signs, each being formed of a unitary piece of flexible magnetic sheet material and having dimensions that correspond to dimensions of the sign-receiving surface of the signboard, and each being adapted for removable connection to the sign-receiving surface of the signboard by magnetic attraction in a manner so that, when connected, the selected sign is coextensive with substantially the entire sign-receiving surface of the signboard.

10. The changeable message display system of claim 9 wherein each signs bears indicia that is distinct from the indicia carried by the other signs.

11. The changeable message display system of claim 8 wherein the outer perimeter of the signboard includes a perimetrical ridge that protrudes from the generally planar sign-receiving surface, the sign being dimensioned to fit against the generally planar sign-receiving surface and within the perimetrical ridge of the signboard.

12. The changeable message display system of claim 8 further comprising a signpost connected to the signboard and having a sharpened distal end adapted to facilitate driving the signpost into the ground.

13. A method of displaying temporary messages:
providing a magnetically attractable signboard having an outer perimeter that defines a generally planar sign-receiving surface;
providing a plurality of signs, each of said signs being formed of a unitary piece of flexible magnetic sheet material and having dimensions substantially the same as the sign-receiving surface of the signboard;
selecting one of said plurality of signs; and
removably connecting the selected sign to the sign-receiving surface of the signboard by magnetic attraction in a manner so that the sign is generally coextensive with substantially the entire sign-receiving surface of the signboard.

14. The method of claim 13 wherein the selected sign constitutes a first selected sign, and the method further comprises the steps of:
removing the first selected sign from the signboard;
selecting a second one of said plurality of signs; and
removably connecting the second selected sign to the sign-receiving surface of the signboard by magnetic attraction in a manner so that the sign is generally coextensive with substantially the entire sign-receiving surface of the signboard.

15. The method of claim 13 wherein the selected sign constitutes a first selected sign, and the method further comprises the steps of:
replacing the first selected sign with a second selecting sign by removing the first selected sign from the signboard; and
removably connecting the second selected sign to the sign-receiving surface of the signboard by magnetic attraction in a manner so that the sign is generally coextensive with substantially the entire sign-receiving surface of the signboard.

16. The method of claim 13 wherein the selected sign constitutes a first selected sign, and the method further comprises the steps of:
selecting a second one of said plurality of signs; and
removably connecting the second selected sign to the signboard by magnetic attraction in a manner so that the sign is generally coextensive with substantially the entire sign-receiving surface of the signboard.

17. The method of claim 16 further comprising the step of removing the first selected sign from the signboard.

18. The method of claim 17 wherein the step of removably connecting the second selected sign to the signboard is performed after the step of removing the first selected sign from the signboard.

19. The method of claim 16 wherein the step of removably connecting the second selected sign to the signboard by magnetic attraction is performed without first removing the first selected sign from the signboard, such that the second selected sign overlays the first selected sign and is generally coextensive therewith.

20. The method of claim 13 further comprising the steps of:
providing a signpost connected to the signboard; and
driving a sharpened distal end of the signpost into a generally horizontal support surface to support the signboard over a support surface.
